(19) United States
(12) Patent Application Publication
(10) Pub. No.: US 2026/0218032 A1
(43) Pub. Date: Jul. 30, 2026

(54) THERMALLY CONDUCTIVE SILICONE COMPOSITION AND METHOD FOR PRODUCING THERMALLY CONDUCTIVE SILICONE COMPOSITION

(71) Applicant: Wacker Chemie AG, Munich (DE)

(72) Inventors: Kazuya SAKAI, Chikusei-shi (JP); Shunsuke YAMADA, Chikusei-shi (JP)

(73) Assignee: Wacker Chemie AG, Munich (DE)

(21) Appl. No.: 19/146,943

(22) PCT Filed: Apr. 11, 2024
(86) PCT No.: PCT/EP2024/059889

§ 371 Date: Jul. 10, 2025

(30) Foreign Application Priority Data
Apr. 27, 2023 (JP) 2023-072886

(51) Int. Cl. C09K 5/14; C08G 77/12; C08G 77/16; C08G 77/20; C08K 3/22; C08K 7/18; C09D 5/18; C09D 7/40; C09D 7/61; C09D 183/06

(52) U.S. Cl. CPC C09K 5/14; C08G 77/12; C08G 77/16; C08G 77/20; C09D 5/18; C09D 7/61; C09D 7/70; C09D 183/06; C08K 2003/2227; C08K 2003/2296; C08K 7/18; C08K 2201/001; C08K 2201/014

(57) ABSTRACT

A thermally conductive silicone composition along with methods of producing and uses for the same. The thermally conductive silicone composition includes a component (A) that is an alkenyl group-containing diorganopolysiloxane, a component (B) that is an organopolysiloxane, a component (C) that is an organopolysiloxane having two or more hydrosilyl groups within one molecule, a component (D) that is a diorganopolysiloxane having no alkenyl group, a component (E) that is an addition reaction catalyst, and a component (F) that is at least one or two or more thermally conductive fillers selected from the group consisting of a metal, a metal oxide, a metal hydroxide, a metal nitride, and a metal carbide. Where the organopolysiloxane of the component (C) is different from the components (A), (B), and (D).

### TECHNICAL FIELD

The present invention relates to a thermally conductive silicone composition and a method for producing a thermally conductive silicone composition.

### BACKGROUND ART

A thermally conductive silicone composition, such as, a gap filler for example, is applied directly to a heat-generating body or a heat-dissipating body, such as a battery of an electric vehicle or a semiconductor of an electronic device, and has a function of transmitting the heat emitted from these bodies to a heat-dissipating member such as a heat sink. Efficient heat transfer at the interface where the coating is formed requires tight contact at the contact interface between the heat-generating body or the like and the gap filler.

For example, with pinpoint precision, a small amount of a gap filler for an electronic device is applied with high accuracy onto a circuit board. This precision requires low unevenness in the coating amount. One factor that causes unevenness in the coating amount is a phenomenon called caking. The term “caking” in the present invention refers to a phenomenon in which, when a gap filler is discharged from a discharge device, a filler and a polymer separate from each other, and only a filler component aggregates in the flow path. Preventing the occurrence of caking is important in terms of both quality and productivity.

Normally, in a gap filler, a thermally conductive filler needs to be contained in a composition at a high relative content in order to obtain a sufficient thermal conductivity. However, a high filler content increases viscosity of the gap filler and impairs discharge performance. If a low-viscosity polymer is used to ensure proper discharge performance, the relative number of organic functional groups in the polymer increases, resulting in poor compatibility with the filler. Such poor compatibility gives rise a concern about the occurrence of caking during the discharge of the gap filler.

Examples of a method for preventing caking include a surface treatment of the filler with a coupling agent. However, even if the amount of the coupling agent is increased, it is difficult to completely treat the filler surface, and compatibility cannot be significantly improved.

Furthermore, if a highly viscous polymer with a high molecular chain, which is highly compatible with the filler, is used, the viscosity of the gap filler increases, causing difficulties in discharging the gap filler.

PTL 1 discloses a precipitation-preventing method for a silicone composition, in which a condensation reaction product of D-sorbitol and benzaldehyde is blended to the composition to produce a precipitation-preventing silicone composition. However, this method has a problem in that high thermal conductive properties cannot be maintained due to the high blending amount of the condensation reaction product relative to the filing agent (filler). Furthermore, PTL 1 addresses the issue of long-term storage stability by preventing separation of the polymer and the filler.

PTL 2 discloses a resin composition with excellent thermal conductive properties due to the uniform dispersion of aluminum nitride powders in the resin without the formation of aggregates. A fluidity modifier is included in order to improve its fluidity. Although PTL 2 improves the fluidity, it does not disclose information that addresses caking that occurs during a long period of discharging under pressure.

### CITATION LIST

### Patent Literature

PTL 1: Japanese Patent No. 2946104
PTL 2: Japanese Patent Application Laid-Open No. Hei. 10-204300

### SUMMARY OF INVENTION

### Technical Problem

The present invention provides a thermally conductive silicone composition and a method for producing the same, the thermally conductive silicone composition having good contact and adhesion to a substrate such as a heat-generating body or a heat-dissipating body, having excellent heat dissipation properties due to a high thermal conductivity, and having caking resistance under discharge pressure while maintaining flexibility.

### Solution to Problem

In a thermally conductive silicone composition of the present invention, a base polymer with high compatibility is used, a separation-inhibition polymer is introduced, the viscosity is adjusted using diorganopolysiloxane, and a thermally conductive filler is included in an appropriate amount. As a result, the thermally conductive silicone composition exhibits high thermal conductive properties, high discharge performance, and caking resistance under discharge pressure.

The thermally conductive silicone composition of the present invention includes:
a component (A) that is an alkenyl group-containing diorganopolysiloxane, having a viscosity of 500 mPa·s or more and 7,000 mPa·s or less at 25° C., in an amount of 1.0 part by mass or more and 9.0 parts by mass or less (relative to 100 parts by mass of the entirety of the composition);
a component (B) that is an organopolysiloxane, having a viscosity of 10,000 mPa·s or more and 200,000 mPa·s or less at 25° C., in an amount of 0.05 parts by mass or more and 1.0 part by mass or less (relative to 100 parts by mass of the entirety of the composition);
a component (C) that is an organopolysiloxane having two or more hydrosilyl groups within one molecule;
a component (D) that is a diorganopolysiloxane having no alkenyl group, having a viscosity of 500 mPa·s or less at 25° C.;
a component (E) that is an addition reaction catalyst; and
a component (F) that is at least one or two or more thermally conductive fillers selected from the group consisting of a metal, a metal oxide, a metal hydroxide, a metal nitride, and a metal carbide, the component (F) being contained in an amount of 85 parts by mass or more relative to 100 parts by mass of the entire thermally conductive silicone composition,
wherein the thermally conductive silicone composition has a mixing viscosity of 250 Pa·s or less at 25° C.

The thermally conductive silicone composition may further include a component (G) that is a coupling agent.

The thermally conductive silicone composition may further include a component (H) that is a silanol group-containing polydimethylsiloxane.

The alkenyl group-containing diorganopolysiloxane of the component (A) may have a vinyl group (Vi) in the side chain, or may have at least one vinyl group (Vi) at each terminal. It is preferable that the alkenyl group-containing diorganopolysiloxane of the component (A) be a linear dimethylpolysiloxane having one Vi group at each terminal, and have a viscosity, at 25° C., of 1,000 mPa·s or more and 1,200 mPa·s or less.

The component (B) may be a non-functional dimethylpolysiloxane. The viscosity, at 25° C., of the component (B) is preferably 80,000 mPa·s or more and 120,000 mPa·s or less.

The component (C) is preferably a dimethylpolysiloxane having 12 to 18 hydrogen atoms bonded to silicon atoms only in the side chain, having a viscosity, at 25° C., of 150 mPa·s or more and 300 mPa·s or less.

The diorganopolysiloxane having no alkenyl group of the component (D) is a non-functional siloxane and may have a trimethylsilyl group at the terminal. The component (D) is preferably a non-functional dimethylpolysiloxane that has a viscosity, at 25° C., of 30 mPa·s or more and 60 mPa·s or less.

The addition reaction catalyst of the component (E) is preferably a platinum-divinyltetramethyldisiloxane complex.

The thermally conductive filler of the component (F) is preferably zinc oxide, an amorphous aluminum oxide, or a spherical aluminum oxide.

The component (H) is preferably a linear dimethylpolysiloxane having one silanol group at each terminal, having a viscosity, at 25° C., of 30 mPa·s or more and 60 mPa·s or less.

The thermally conductive silicone composition is a two-component thermally conductive silicone composition including a first liquid and a second liquid separated from each other, the first liquid and the second liquid being mixed (e.g., in a discharge device under pressure) when used;
the first liquid may contain the components (A), (B), (D), (E), and (F); and
the second liquid may contain the components (B), (C), (D), and (F), but not the component (E).

The second liquid may further contain the component (A).

The first liquid and/or the second liquid may further contain the component (G) that is a coupling agent.

The first liquid and/or the second liquid may further contain the component (H) that is a silanol group-containing polydimethylsiloxane.

When the total blending amount of the first liquid and/or the total blending amount of the second liquid is 100 parts by mass, the component (A) is preferably contained in an amount of 2.5 parts by mass or more and 3.0 parts by mass or less.

When the total blending amount of the first liquid and/or the total blending amount of the second liquid is 100 parts by mass, the component (B) is preferably contained in an amount of 0.2 parts by mass or more and 0.4 parts by mass or less.

When the total blending amount of the second liquid is 100 parts by mass, the component (C) is preferably contained in an amount of 0.3 parts by mass or more and 0.5 parts by mass or less.

When the total blending amount of the first liquid and/or the total blending amount of the second liquid is 100 parts by mass, the component (D) is preferably contained in an amount of 4.5 parts by mass or more and 5.5 parts by mass or less.

When the total blending amount of the first liquid is 100 parts by mass, the component (E) is preferably contained in an amount of 0.15 parts by mass or more and 0.25 parts by mass or less.

When the total blending amount of the first liquid and/or the total blending amount of the second liquid is 100 parts by mass, zinc oxide as the component (F) is preferably contained in an amount of 4.0 parts by mass or more and 8.0 parts by mass or less.

When the total blending amount of the first liquid and/or the total blending amount of the second liquid is 100 parts by mass, amorphous aluminum oxide as the component (F) is preferably contained in an amount of 20.0 parts by mass or more and 40.0 parts by mass or less.

When the total blending amount of the first liquid and/or the total blending amount of the second liquid is 100 parts by mass, spherical aluminum oxide as the component (F) is preferably contained in an amount of 45.0 parts by mass or more and 65.0 parts by mass or less.

When the total blending amount of the first liquid and/or the total blending amount of the second liquid is 100 parts by mass, the component (G) is preferably contained in an amount of 0.4 parts by mass or more and 0.5 parts by mass or less.

When the total blending amount of the first liquid and/or the total blending amount of the second liquid is 100 parts by mass, the component (H) is preferably contained in an amount of 0.25 parts by mass or more and 0.35 parts by mass or less.

It is preferable that, in the thermally conductive silicone composition, the absence of aggregation in any of the first liquid, the second liquid, and the thermally conductive silicone composition be visually confirmed by the following caking evaluation.

### Caking Evaluation:

Using a dispenser (for example, MPP-3 manufactured by Musashi Engineering Inc.), discharging a material with a volume of 0.03 cc and a standby period of 0.20 seconds are repeated to discharge 1.0 kg of the material. The dispenser is then disassembled to visually check for aggregation.

A method for producing a two-component thermally conductive silicone composition of the present invention includes;
a first liquid production step of mixing a component (A) that is an alkenyl group-containing diorganopolysiloxane, having a viscosity of 500 mPa·s or more and 7,000 mPa·s or less at 25° C., in an amount of 1.0 part by mass or more and 9.0 parts by mass or less (relative to 100 parts by mass of the entirety of the composition), a component (B) that is an organopolysiloxane, having a viscosity of 10,000 mPa·s or more and 200,000 mPa·s or less at 25° C., in an amount of 0.05 parts by mass or more and 1.0 part by mass or less (relative to 100 parts by mass of the entirety of the composition), a component (D) that is a diorganopolysiloxane having no alkenyl group, having a viscosity of 500 mPa·s or less at 25° C., and a component (E) that is an addition reaction catalyst, and then mixing a component (F) that is at least one or two or more thermally conductive fillers selected from the group consisting of a metal, a metal oxide, a metal hydroxide, a metal nitride, and a metal carbide, to obtain a first liquid; and
a second liquid production step of mixing the component (B) that is an organopolysiloxane, having a viscosity of 10,000 mPa·s or more and 200,000 mPa·s or less at 25° C., in an amount of 0.05 parts by mass or more and 1.0 part by mass or less (relative to 100 parts by mass of the entirety of the composition), a component (C) that is an organopolysiloxane having two or more hydrosilyl groups within one molecule, the component (D) that is a diorganopolysiloxane having no alkenyl group, having a viscosity of 500 mPa·s or less at 25° C., and the component (F) that is at least one or two or more thermally conductive fillers selected from the group consisting of a metal, a metal oxide, a metal hydroxide, a metal nitride, and a metal carbide, to obtain a second liquid.

In the second liquid production step, before the component (F) is added, the component (A) that is an alkenyl group-containing diorganopolysiloxane, having a viscosity of 500 mPa·s or more and 7,000 mPa·s or less at 25° C., in an amount of 1.0 part by mass or more and 9.0 parts by mass or less may be mixed with the other components.

In the first liquid production step and/or the second liquid production step, before the component (F) is added, a component (G) that is a coupling agent may be mixed with the other components.

In the first liquid production step and/or the second liquid production step, before the component (F) is added, a component (H) that is a silanol group-containing polydimethylsiloxane may be mixed with the other components.

The method for producing a two-component thermally conductive silicone composition may include:
a first liquid packaging step of filling the first liquid obtained in the first liquid production step into a predetermined first packaging material; and
a second liquid packaging step of filling the second liquid obtained in the second liquid production step into a predetermined second packaging material.

A method for discharging the thermally conductive silicone composition of the present invention may include steps of:
introducing the first liquid from the first packaging material into a first liquid flow path of a dispenser;
introducing the second liquid from the second packaging material into a second liquid flow path of the dispenser;
introducing the first liquid and the second liquid at a predetermined ratio into a merging flow path where the first liquid flow path and the second liquid flow path merge; and
discharging a mixed liquid of the first liquid and the second liquid, which are brought into contact with each other in the merging flow path, from a nozzle of the dispenser onto a substrate.

The above-described term “predetermined ratio” refers to a mixing ratio of the first liquid and the second liquid, which is set according to specifications of the thermally conductive silicone composition.

A method for producing a thermally conductive member of the present invention may include:
a step of discharging the first liquid from a first liquid storage unit to a mixing unit;
a step of discharging the second liquid from a second liquid storage unit to the mixing unit;
a step of mixing the first liquid and the second liquid in the mixing unit to obtain a thermally conductive silicone composition;
a step of discharging and applying the thermally conductive silicone composition onto a substrate; and
a step of curing the thermally conductive silicone composition applied onto the substrate to obtain a thermally conductive member.

In the method for producing a thermally conductive member and the method for discharging a thermally conductive silicone composition, a discharge pressure for discharging the first liquid, the second liquid, and the thermally conductive silicone composition onto the substrate may vary depending on the dispenser. However, the lower limit of the discharge pressure is, for example, 0.1 MPa, preferably 0.2 MPa to 0.8 MPa.

A heat-dissipating member of the present invention may include a substrate and a thermally conductive member disposed on the surface of the substrate, the thermally conductive member being obtained by curing the above-mentioned thermally conductive silicone composition.

An electrical device or electronic device of the present invention may include the heat-dissipating member described above.

### Action and Effects

(1) The thermally conductive silicone composition achieves good contact and adhesion to a substrate such as a heat-dissipating body, is excellent in heat dissipation properties due to a high thermal conductivity, and is useful as a gap filler that prevents caking while maintaining high discharge performance.
(2) The thermally conductive silicone composition of the present invention is useful as a thermally conductive silicone composition that is less likely to clog the flow path even during a long period of discharging.

### DESCRIPTION OF EMBODIMENTS

Hereinafter, a thermally conductive silicone composition, a method for producing the thermally conductive silicone composition, a method for producing a thermally conductive member, and a heat-dissipating member, according to the present invention will be described in detail.

Thermally conductive silicone composition:

The thermally conductive silicone composition may be any composition for forming the thermally conductive member. Examples of the thermally conductive member include a heat-generating body such as a car battery, a gap filler or a heat-dissipating sheet applied onto a film that covers a heat-generating body, and a member that is cured and formed on a substrate, a circuit chip, a heat-dissipating member, or the like for an electrical device or an electronic device.

The thermally conductive silicone composition may be applied to a substrate in a liquid state before curing and may be cured after application to provide the thermally conductive member. Alternatively, the thermally conductive silicone composition may be cured to obtain a thermally conductive member, and then the thermally conductive member may be applied to a substrate.

The temperature, procedure, and the like for curing the thermally conductive silicone composition are not limited and can be appropriately selected depending on the use application or the like of the cured product to be obtained. The present invention provides a thermally conductive silicone composition that can exhibit sufficient performance, that is, sufficient curability, adhesion to a substrate under a discharge pressure, and caking resistance even when its use is limited to only a normal temperature environment. However, the thermally conductive silicone composition can be cured in a high-temperature environment in a case where such a high-temperature environment is permitted.

A curing method of the thermally conductive silicone composition is preferably an addition reaction type. The main reasons for this are, for example, as follows: curing can be controlled over a wide temperature range of room temperature to around 150° C., volume change and the amount of desorption gas are low, and there is generally good compatibility with a thermally conductive filling agent. In general, the higher the curing temperature, the faster the curing process. The present invention assumes that some or all of the step of applying the thermally conductive silicone composition, the curing step, and the subsequent steps are required to be performed at room temperature due to various restrictions depending on the use application. The addition reaction type allows the curing temperature to be set appropriately according to the restrictions.

Assuming that the curing method of the thermally conductive silicone composition according to the present invention is the addition reaction type, each component of the thermally conductive silicone composition will be described in detail below.

### Component (A):

The component (A), which is the main component of the thermally conductive silicone composition, is an alkenyl group-containing diorganopolysiloxane. The alkenyl group-containing diorganopolysiloxane preferably has a terminal Vi (vinyl group) in order to have a moderate hardness after curing. The alkenyl group-containing diorganopolysiloxane may have an OH group at its terminal.

The viscosity and the degree of polymerization of the component (A) are not particularly limited, and can be selected according to the required mixing viscosity and the like of the thermally conductive silicone composition, and the viscosity at 25° C. may be, for example, 500 mPa·s or more and 7,000 mPa·s or less.

As the diorganopolysiloxane, one type thereof may be used alone, or two or more types thereof may be used in combination as appropriate. The diorganopolysiloxane is the main component of the thermally conductive silicone composition and has, on average, at least two alkenyl groups bonded to silicon atoms within one molecule, preferably 2 to 50 alkenyl groups, and more preferably 2 to 20 alkenyl groups.

The amount of the component (A) is in the range of 1.0 part by mass or more and 9.0 parts by mass or less, preferably 2 parts by mass or more and 4 parts by mass or less, relative to 100 parts by mass of the entirety of the thermally conductive silicone composition. The component (A) is preferably contained in both the first liquid and the second liquid.

The molecular structure of the component (A) is not particularly limited, and may be, for example, a linear structure, a partially branched linear structure, a branched chain structure, a cyclic structure, or a branched cyclic structure. Among these, the component (A) is preferably a substantially linear diorganopolysiloxane. Specifically, the component (A) can be a linear diorganopolysiloxane in which the molecular chain is mainly composed of a diorganosiloxane repeat unit and of which both terminals of the molecular chain are blocked with a triorganosiloxy group. Some or all of the terminals of the molecular chain or a part of the side chain may be a silanol group.

The position of the alkenyl group bonded to the silicon atom in the component (A) is not particularly limited, and the component (A) may be a diorganopolysiloxane having an alkenyl group bonded to a silicon atom at both molecular chain terminals. The diorganopolysiloxane having one alkenyl group at each terminal of the molecular chain has an advantage in that the content of the alkenyl groups serving as the reaction point of the cross-linking reaction is small and the flexibility of the cured product, e.g., gap filler, obtained after curing is enhanced.

The alkenyl group may be bonded to the silicon atom at the molecular chain terminal, to the silicon atom at a non-terminal molecular chain site (in the middle of the molecular chain), or to both.

The component (A) may be a polymer composed of a single type of siloxane unit or a copolymer composed of two or more types of siloxane units.

The viscosity, at 25° C., of the component (A) is 500 mPa·s or more and 7,000 mPa·s or less, preferably 1,000 mPa·s or more and 5,000 mPa·s or less, more preferably 1,000 mPa·s or more and 4,000 mPa·s or less, and even more preferably 1,000 mPa·s or more and 2,000 mPa·s or less.

When the viscosity falls within the above-described range, an appropriate fluidity of the resulting thermally conductive silicone composition can be obtained, and thus the discharge performance is high and the productivity can thus be improved. In addition, it is possible to increase the flexibility of the resulting thermally conductive member obtained by curing the thermally conductive silicone composition.

In order to adjust the viscosity (mixing viscosity), before curing, of the thermally conductive silicone composition that is obtained by mixing the liquid compositions, two or more types of diorganopolysiloxanes having an alkenyl group and having different viscosities can also be used in combination.

Specifically, the component (A) is represented by the following general formula (1) as an average composition formula:

R¹ₐSiO_{(4-a)/2} (1)

(In the formula (1), R's are the same as or different from each other and each are an unsubstituted or substituted monovalent hydrocarbon group having 1 to 18 carbon atoms, a is 1.7 to 2.1, preferably 1.8 to 2.5, and more preferably 1.95 to 2.05.).

In one embodiment, at least two or more of the monovalent hydrocarbon groups represented by the aforementioned R¹ are selected from alkenyl groups such as a vinyl group, an allyl group, a propenyl group, an isopropenyl group, a butenyl group, an isobutenyl group, a hexenyl group, and a cyclohexenyl group. Groups other than these groups are substituted or unsubstituted monovalent hydrocarbon groups having 1 to 18 carbon atoms. Specifically, the aforementioned R¹ is selected from the group consisting of an alkyl group such as a methyl group, an ethyl group, a propyl group, an isopropyl group, a butyl group, an isobutyl group, a tert-butyl group, a pentyl group, a neopentyl group, a hexyl group, a 2-ethylhexyl group, a heptyl group, an octyl group, a nonyl group, a decyl group, and a dodecyl group; a cycloalkyl group such as a cyclopentyl group, a cyclohexyl group, and a cycloheptyl group; an aryl group such as a phenyl group, a tolyl group, a xylyl group, a biphenyl group, and a naphthyl group; an aralkyl group such as a benzyl group, a phenylethyl group, a phenylpropyl group, and a methylbenzyl group; and a halogen-substituted or cyano-substituted alkyl group in which a part or all of hydrogen atoms in the above-described hydrocarbon groups have been substituted with a halogen atom, a cyano group, or the like, such as a chloromethyl group, a 2-bromoethyl group, a 3,3,3-trifluoropropyl group, a 3-chloropropyl group, and a cyanoethyl group.

Examples of R's to be selected preferably include, as the two or more alkenyl groups required, a vinyl group, an allyl group, a propenyl group, an isopropenyl group, a 2-methyl-1-propenyl group, a 2-methylallyl group, and a 2-butenyl group. A vinyl group is particularly preferable. Preferable examples of R¹ other than the alkenyl group include a methyl group and a phenyl group, with a methyl group being particularly preferable. In addition, it is preferable that 70 mol % or more of R's be a methyl group, in consideration of physical properties and economic efficiency of the cured product, and normally, it is preferable that 80 mol % or more of R's be a methyl group.

Specific examples of the molecular structure of the component (A) include a dimethylpolysiloxane with both molecular chain terminals blocked with a dimethylvinylsiloxy group, a dimethylsiloxane-methylphenylsiloxane copolymer with both molecular chain terminals blocked with a dimethylvinylsiloxy group, a dimethylsiloxane-methylvinylsiloxane copolymer with both molecular chain terminals blocked with a dimethylvinylsiloxy group, a dimethylsiloxane-methylvinylsiloxane-methylphyenylsiloxane copolymer with both molecular chain terminals blocked with a dimethylvinylsiloxy group, a dimethylsiloxane-methylvinylsiloxane copolymer with both molecular chain terminals blocked with a trimethylsiloxy group, an organopolysiloxane composed of a siloxane unit represented by the formula: (CH₃)₂ViSiO_{1/2}, a siloxane unit represented by the formula: (CH₃)₃SiO_{1/2}, and a siloxane unit represented by the formula: SiO_{4/2} (Vi in the formula represents a vinyl group), an organopolysiloxane in which part or all of the methyl groups in the above-mentioned organopolysiloxanes are substituted by an alkyl group such as an ethyl group or a propyl group, an aryl group such as a phenyl group or a tolyl group, and a halogenated alkyl group such as a 3,3,3-trifluoropropyl group, and mixtures of two or more of these organopolysiloxanes. From the viewpoint of enhancing stretchability at the time of breakage of the cured product due to increased molecular chain length, a linear diorganopolysiloxane with one vinyl group at each molecular chain terminal is preferable.

The component (A) may include an alkenyl group-containing diorganopolysiloxane having at least one silanol group at the molecular chain terminal in an amount of 1.0 part by mass or more and 9.0 parts by mass or less.

When the thermally conductive silicone composition of the present invention is stored as a two-component composition, the alkenyl group-containing diorganopolysiloxane having a silanol group may be contained to the first liquid and/or the second liquid.

These diorganopolysiloxanes may be commercially available or prepared by methods known to those skilled in the art.

### Component (B):

The component (B) is an organopolysiloxane.

The component (B) may have a viscosity and a degree of polymerization that are not particularly limited, and can be selected according to the required mixing viscosity and the like of the thermally conductive silicone composition. For example, the component (B) may have a viscosity, at 25° C., of 10,000 mPa·s or more and 200,000 mPa·s or less.

The component (B) is an organopolysiloxane, and is a component that serves as a separation inhibitor for suppressing separation of the polymer and the filler under a discharge pressure.

The component (B) may be any organohydrogenpolysiloxane. For example, the component (B) may have the same structure as that of the component (A), or may be a diorganopolysiloxane having no vinyl group.

The viscosity, at 25° C., of the component (B) is 10,000 mPa·s or more and 200,000 mPa·s or less, preferably 10,000 mPa·s or more and 150,000 mPa·s or less, and more preferably 15,000 mPa·s or more and 100,000 mPa·s or less.

### Component (C):

The component (C) is an organopolysiloxane having two or more hydrosilyl groups within one molecule. The component (C) may function as a cross-linking agent.

The component (C) may have a viscosity and a degree of polymerization that are not particularly limited and that can be selected according to the required mixing viscosity of the thermally conductive silicone composition. For example, the component (C) may have a viscosity, at 25° C., of 10 mPa·s or more and 10,000 mPa·s or less.

The component (C) may be a diorganopolysiloxane having three or more hydrosilyl groups bonded to silicon atoms within one molecule, and serves as a cross-linking agent for curing the thermally conductive silicone composition.

The number of the hydrosilyl groups bonded to silicon atoms is not particularly limited as long as the number is 2 or more.

The hydrogen content (H content) of the component (C) is not particularly limited. In order to impart a practically sufficient stretchablity to a thermally conductive member obtained by curing the thermally conductive silicone composition, the hydrogen content (H content) of the component (C) is preferably 0.01 mmol/g or more and 4.0 mmol/g or less, more preferably 0.3 mmol/g or more and 3.0 mmol/g or less, and even more preferably 1.0 mmol/g or more and 2.0 mmol/g or less.

As the component (C), an organohydrogenpolysiloxane can be used. The component (C) forms a cured product by an addition reaction with an alkenyl group, and may have a hydrogen atom (hydrosilyl group) bonded to at least one or more silicon atoms in a side chain in the molecule.

The component (C) may function as a cross-linking agent. The component (C) that serves as the cross-linking agent preferably has three or more hydrosilyl groups within one molecule and may have at least one hydrosilyl group in a side chain in the molecule. The component (C) that serves as the cross-linking agent is more preferably an organohydrogenpolysiloxane having 5 or more hydrosilyl groups, and may have 10 or more and 18 or less hydrosilyl groups. The organohydrogenpolysiloxane that serves as the cross-linking agent has at least two hydrosilyl groups in its side chain. The number of hydrosilyl groups at a molecular chain terminal may be zero or more and two or less, and is, from an economic perspective, preferably two. The molecular structure of the organohydrogenpolysiloxane may be any of linear, cyclic, branched, and three-dimensional network structures. The position of the silicon atom to which a hydrogen atom is bonded is not particularly limited, and may be at a molecular chain terminal, at a non-terminal molecular chain site (in the middle of the molecular chain), or in a side chain. Other conditions, the type of the organic group other than a hydrosilyl group, the bonding position, the degree of polymerization, the structure, and the like in the organohydrogenpolysiloxane are not particularly limited. Two or more types of organohydrogenpolysiloxanes may be used in combination.

In the thermally conductive silicone composition described above, the content of the component (C) is preferably in such a range that the ratio of the number of hydrosilyl groups in the component (C) to that of the alkenyl group in the components (A) and (B) falls within the range of ⅕ to 7, more preferably within the range of ½ to 2, and still more preferably within the range of ⅖ to 5/4. When the content of the component (C) falls within the aforementioned range, the thermally conductive silicone composition is sufficiently cured and the hardness of the entire cured product obtained by curing the composition falls within a more preferable range. As a result, cracks are less likely to occur when the cured product of the composition is used as a gap filler. In addition to these, there is an advantage that the cured product achieves both a desired certain degree of flexibility and adhesion.

The hydrosilyl group in the component (C) may be present at the molecular chain terminals, may be present in side chains, or may be present both at the molecular chain terminals and in the side chains. It is preferable to use a mixture of an organohydrogenpolysiloxane having one hydrosilyl group only at each molecular chain terminal and an organohydrogenpolysiloxane having hydrosilyl groups only in the side chain of the molecular chain.

From the viewpoint of improving heat resistance, the component (C) may include an organohydrogenpolysiloxane having at least one aromatic group within the molecule. For economic reasons, the aromatic group is more preferably a phenyl group. An aromatic group-containing organohydrogenpolysiloxane and an aromatic group-free organohydrogenpolysiloxane may be used in combination.

The viscosity, at 25° C., of the component (C) is 10 mPa·s or more and 10,000 mPa·s or less, preferably 20 mPa·s or more and 5,000 mPa·s or less, and more preferably 30 mPa·s or more and 2,000 mPa·s or less.

In order to adjust the viscosity of the thermally conductive silicone composition, which is the final product, it is also possible to use two or more types of organopolysiloxanes having two or more hydrosilyl groups and having different respective viscosities. The mixing viscosity of the thermally conductive silicone composition may be in the range of 10 Pa·s or more and 1,000 Pa·s or less, more preferably in the range of 20 Pa·s or more and 500 Pa·s or less, and even more preferably in the range of 30 Pa·s or more and 250 Pa·s or less.

In the thermally conductive silicone composition according to the present invention, the content of the component (C) is preferably in such a range that the ratio of the number of hydrosilyl groups in the component (C) to that of the alkenyl group in the components (A) and (B) falls within the range of ⅕ to 7.

When the content of the component (C) falls within the aforementioned range, the hardness of the cured product of the thermally conductive silicone composition becomes able to fall within an appropriate range.

### Component (D):

The component (D) is a diorganopolysiloxane containing no alkenyl group.

The component (D) functions as a viscosity controller for the thermally conductive silicone composition. The viscosity of the component (D) is 500 mPa·s or less at 25° C.

The molecular structure of the component (D) is not particularly limited, and the component (D) is, for example, a linear, branched or cyclic diorganopolysiloxane, and preferably a linear diorganopolysiloxane.

Specific examples of the component (D) include a linear dimethylpolysiloxane with both terminals blocked with a trimethylsilyl group and a linear diethylpolysiloxane with both terminals blocked with a triethylsilyl group. In particular, the component (D) is preferably a linear dimethylpolysiloxane with both terminals blocked with a trimethylsilyl group.

### Component (E):

The component (E) is an addition reaction catalyst, and promotes an addition-curing reaction between an alkenyl group bonded to a silicon atom in the component (A) described above and a hydrogen atom bonded to a silicon atom in the component (C) described above.

Such addition reaction catalysts are known to those skilled in the art. Examples of the component (E) include a platinum group metal such as platinum, rhodium, palladium, osmium, iridium, and ruthenium, and catalysts in which any of the aforementioned metals is supported by a particulate carrying material (for example, activated carbon, aluminum oxide, and silicon oxide).

Furthermore, specific examples of the component (E) include a platinum halide, a platinum-olefin complex, a platinum-alcohol complex, a platinum-alcoholate complex, a platinum-vinylsiloxane complex, dicyclopentadiene-platinum dichloride, cyclooctadiene-platinum dichloride, and cyclopentadiene-platinum dichloride.

In addition, from an economic viewpoint, a metal compound catalyst other than platinum group metals as described above may be used as the component (E). Examples of the iron catalyst for hydrosilylation include an iron-carbonyl complex catalyst, an iron catalyst having a cyclopentadienyl group as a ligand, an iron catalyst having a terpyridine-based ligand or a combination of a terpyridine-based ligand and a bistrimethylsilylmethyl group, an iron catalyst having a bisiminopyridine ligand, an iron catalyst having a bisiminoquinoline ligand, an iron catalyst having an aryl group as a ligand, an iron catalyst having a cyclic or acyclic olefin group with an unsaturated group, and an iron catalyst having a cyclic or acyclic olefinyl group with an unsaturated group. Other examples of the catalyst for hydrosilylation include a cobalt catalyst, a vanadium catalyst, a ruthenium catalyst, an iridium catalyst, a samarium catalyst, a nickel catalyst, and a manganese catalyst.

The blending amount of the component (E) is, in terms of the concentration of the catalyst metal element, in the range of preferably 0.5 ppm or more and 1,000 ppm or less, more preferably 1 ppm or more and 500 ppm or less, and still more preferably 1 ppm or more and 100 ppm or less, relative to the total mass of the thermally conductive silicone composition, although an effective amount thereof according to the curing temperature and curing time desired depending on the use applications is used. If the blending amount is less than 0.5 ppm, the addition reaction will become remarkably slow. If the blending amount exceeds 1,000 ppm, it is not economically preferable because of cost increase.

### Component (F):

The thermally conductive filler of the component (F) is a filling material component that improves the thermal conductivity of the thermally conductive silicone composition. The thermally conductive filler of the component (F) is at least one or more selected from the group consisting of a metal, a metal oxide, a metal hydroxide, a metal nitride, and a metal carbide. In order to obtain a gap filler having high insulating properties for application to an electronic substrate or the like, it is preferable to use a material having excellent insulating properties as well as thermal conductive properties as the thermally conductive filler of the component (F).

Examples of the thermally conductive filler of the component (F) include a metal oxide such as aluminum oxide, zinc oxide, magnesium oxide, titanium oxide, silicon oxide, and beryllium oxide; a metal hydroxide such as aluminum hydroxide and magnesium hydroxide; a nitride such as aluminum nitride, silicon nitride, and boron nitride; a carbide such as boron carbide, titanium carbide, and silicon carbide; graphite such as graphite and black lead; metal such as aluminum, copper, nickel, and silver; and mixtures thereof. In particular, when electrical insulation is required for the thermally conductive silicone composition, the component (F) is preferably a metal oxide, a metal hydroxide, a nitride, or a mixture thereof, and may be an amphoteric hydroxide or an amphoteric oxide. The component (F) that can be used is preferably one or two or more types selected from the group consisting of aluminum hydroxide, boron nitride, aluminum nitride, zinc oxide, aluminum oxide, magnesium oxide, and magnesium hydroxide.

It should be noted that aluminum oxide, aluminum hydroxide, magnesium oxide, magnesium hydroxide, zinc oxide, aluminum nitride, and boron nitride are insulating materials, and have relatively good compatibility with the components (A) and (B). Furthermore, they are industrially selectable varieties having a wide range of particle sizes, are readily available in resources, and are relatively inexpensive. Therefore, they are suitable as thermally conductive inorganic filling materials.

In the thermally conductive silicone composition of the present invention, it is more preferable to use at least one selected from the group consisting of aluminum oxide, aluminum hydroxide, magnesium oxide, magnesium hydroxide, zinc oxide, aluminum nitride, and boron nitride as the component (F). When only one type thereof is used as the component (F), aluminum oxide, aluminum hydroxide, or zinc oxide is preferably selected, and aluminum oxide is more preferably selected. Even when only one type is used, it is more preferable to combine two or more types of different shapes. For example, a combination of spherical aluminum oxide and amorphous aluminum oxide or a combination of spherical zinc oxide and amorphous zinc oxide may be used.

As the component (F), it is more preferable to use at least two types selected from the group consisting of aluminum oxide, aluminum hydroxide, magnesium oxide, magnesium hydroxide, zinc oxide, aluminum nitride, and boron nitride. For example, a combination of spherical aluminum oxide, amorphous aluminum oxide, and amorphous zinc oxide may be used.

The shape of the thermally conductive filler is not particularly limited and may be, for example, a spherical shape, an amorphous shape, a fine powder, a fibrous shape, a scaly shape, or the like. In order to blend the amount of the thermally conductive filler required to enhance the thermal conductive properties of the thermally conductive member, the thermally conductive filler preferably has a spherical shape, and the average particle diameter thereof may be 1 to 100 μm. Herein, the spherical shape may be not only a true spherical shape but also an oval sphere shape.

When spherical aluminum oxide is used as the component (F), α-alumina obtained by high-temperature thermal spraying or hydrothermal treatment of alumina hydrate may be used.

In order to improve the filling rate of the thermally conductive filler, it is more preferable to use a spherical thermally conductive filler and a thermally conductive filler other than a spherical filler. When at least two or more types of thermally conductive fillers having different shapes are used in combination, the fillers can be packed in a state that is almost the closest packed, so that the effect of increasing the thermal conductive properties can be obtained. When the spherical thermally conductive filler is used in combination with a thermally conductive filler other than spherical fillers (for example, an amorphous thermally conductive filler), thermal conductive properties can be further increased.

The thermally conductive filler preferably has a thermal conductivity of 10 W/m·K or more. When the thermal conductivity is less than 10 W/m·K, the thermal conductivity itself of the thermally conductive silicone composition may be reduced.

In particular, if the thermally conductive member requires electrical insulation properties, it is conceivable to select a non-electroconductive thermally conductive filler.

The thermally conductive filler may be blended in an amount required to increase the thermal conductive properties of the thermally conductive member (e.g., 2.0 W/m·K or higher). For example, the content of the component (F) may be 70 parts by mass or more and 95 parts by mass or less relative to 100 parts by mass of the entire thermally conductive silicone composition.

When the content of the component (F) falls within the above-mentioned range, the thermally conductive silicone composition as a whole has sufficient thermal conductivity, is easy to mix at the time of blending, and maintains flexibility even after curing. In addition, since the component (F) contained in such an amount does not excessively increase the specific gravity, the resulting composition is more suitable for forming a thermally conductive member that is required to have high thermal conductive properties and reduced weight. If the content of the component (F) is too small, it becomes difficult to sufficiently increase the thermal conductivity of the cured product obtained from the thermally conductive silicone composition, whereas if the content of the component (F) is too large, the resulting thermally conductive silicone composition becomes highly viscous, and there is a possibility that it becomes difficult to uniformly apply the thermally conductive silicone composition. Thus, such cases result in problems such as an increase in the thermal resistance value of the cured product of the composition and a decrease in flexibility of the cured product.

The average particle diameter of the component (F) is not particularly limited and may be in the range of 1 μm or more and 100 μm or less. If the average particle diameter is too small, the fluidity of the thermally conductive silicone composition is lowered. If the average particle diameter is too large, there is a possibility that problems could occur such as the scraping of the coating apparatus due to the filler being caught by sliding portions of the coating apparatus. Note that the average particle diameter of the component (F) is defined by D50 (or median diameter) that is the 50% particle diameter in the volume-based cumulative particle size distribution measured by a laser diffraction particle size measuring device.

### Component (G):

Examples of the coupling agent of the component (G) include a silane coupling agent.

Examples of the silane coupling agent include an organosilicon compound and an organosiloxane having an organic group having 3 or more carbon atoms and a silicon atom-bonded alkoxy group within one molecule, the organic group including an epoxy group, an alkyl group, an aryl group, a vinyl group, a styryl group, a methacryl group, an acryl group, an amino group, an isocyanurate group, a ureide group, a mercapto group, an isocyanate group, and an acid anhydride. An example of the silane coupling agent is a silane compound such as octyltrimethoxysilane, octyltriethoxysilane, decyltrimethoxysilane, decyltriethoxysilane, dodecyltrimethoxysilane, dodecyltriethoxysilane, vinyltrimethoxysilane, 3-glycidoxypropyltrimethoxysilane, p-styryltrimethoxysilane, 3-methacryloxypropyltrimethoxysilane, 3-acryloxypropyltrimethoxysilane, 3-aminopropyltrimethoxysilane, 3-aminopropyltriethoxysilane, tris-(trimethoxysilylpropyl)isocyanurate, 3-ureidopropyltrialkoxysilane, 3-mercaptopropylmethyldimethoxysilane, 3-isocyanatopropyltriethoxysilane, and 3-trimethoxysilylpropyl succinic anhydride. The silane compound may be a compound having no hydrosilyl group. One type thereof may be used alone, or two or more types thereof may be used in combination as appropriate. When the surface of the thermally conductive filler is treated with the silane coupling agent, the affinity with the silicone polymer can be improved, the viscosity of the composition can be decreased, and the filling properties of the thermally conductive filler can be improved. Therefore, when a larger amount of the thermally conductive filler is added, thermal conductivity can be improved.

As the blending amount of the silane coupling agent relative to that of the thermally conductive filler, an effective amount according to curing temperature or curing time desired depending on the use applications is used. A general optimum amount is usually 0.5 wt % or more and 2 wt % or less relative to the amount of the thermally conductive filler. A standard of a required amount is calculated by the following expression. The silane coupling agent may be added in an amount one to three times the standard of the required amount.

Required amount (g) of silane coupling agent=Mass (g) of thermally conductive filler×Specific surface area (m²/g) of thermally conductive filler/Minimal covering area specific to silane coupling agent (m²/g)

### Component (H):

The component (H) is a polydimethylsiloxane containing a silanol group. The component (H) exhibits a function of improving thread breakage properties of the discharged liquid. The viscosity of the component (H) is 10 mPa·s or more and 1,000 mPa·s or less at 25° C., more preferably 10 mPa·s or more and 500 mPa·s or less at 25° C.

The silanol group-containing organopolysiloxane having a viscosity of 10 mPa·s or more and 500 mPa·s or less at 25° C. as the components (H) is blended in order to improve storage stability of the thermally conductive silicone composition and also to improve flexibility and pump-out resistance of the thermally conductive member that is obtained by curing the composition.

The component (H) can be a compound that has no alkenyl group or no hydrogen atom (no hydrosilyl group) bonded to a silicon atom. Furthermore, the component (H) may be a linear organopolysiloxane having at least one silanol group at each molecular chain terminal. If the component (H) has such a structure, the thread breakage properties are improved accordingly.

Specific examples of the component (H) include a linear dimethylpolysiloxane with both terminals blocked with a dimethylhydroxysilyl group, and a linear diethylpolysiloxane with both terminals blocked with a diethylhydroxysilyl group. In particular, a linear dimethylpolysiloxane with both terminals blocked with a dimethylhydroxysilyl group is preferable.

In the other components (for example, the component (D)), silanol groups may be contained at an inevitable amount level (for example, 0.001 parts by mass or less based on the total amount of the component), and when contained, the silanol group does not account for the blending amount of the component (H).

In the thermally conductive silicone composition, as an additional optional component other than the aforementioned components (A) to (G), a conventionally known additive for use in a silicone rubber or gel can be used as long as the object of the present invention is not impaired. Examples of such additives include an organosilicon compound, a cross-linking agent, an adhesive aid, a pigment, a dye, a curing inhibitor, a heat-resistance imparting agent, a flame retardant, an antistatic agent, a conductivity imparting agent, an airtightness improving agent, a radiation shielding agent, an electromagnetic wave shielding agent, a preservative, a stabilizer, an organic solvent, a plasticizer, a fungicide, an organopolysiloxane that contains one hydrogen atom or alkenyl group bonded to a silicon atom within one molecule and that contains no other functional groups, and a silicon atom-bonded hydrogen atom. As these optional components, one type thereof may be used alone, or two or more types thereof may be used in combination as appropriate.

The thermally conductive silicone composition of the present invention may contain any one or more selected from the group consisting of octamethylcyclotetrasiloxane (D4), decamethylcyclopentasiloxane (D5), dodecamethylcyclohexasiloxane (D6), tetradecamethylcycloheptasiloxane (D7), and hexadecamethylcyclooctasiloxane (D8). The total content of (D4), (D5), (D6), (D7), and (D8) may be less than 0.1 parts by mass (i.e., less than 1,000 ppm) relative to 100 parts by mass of the total blending amount of the first liquid and/or the total blending amount of the second liquid.

### Substrate:

Here, the substrate may be at least one selected from glass, metals, ceramics, and resins.

Preferable examples of the metal substrate to which the thermally conductive silicone composition is bonded include those made of aluminum, magnesium, iron, nickel, titanium, stainless steel, copper, lead, zinc, molybdenum, and silicon.

Preferable examples of the ceramic substrate to which the thermally conductive silicone composition is bonded include those made of an oxide, a carbide, and a nitride, such as aluminum oxide, aluminum nitride, alumina zirconia, zirconium oxide, zinc oxide, barium titanate, lead zirconate titanate, beryllium oxide, silicon nitride, and silicon carbide.

Preferable examples of the resin substrate to which the cured thermally conductive silicone composition is bonded include resin substrates made of a polyester, an epoxy resin, a polyamide, a polyimide, an ester-based resin, a polyacrylamide, an acrylonitrile-butadiene-styrene (ABS) resin, a styrene-based resin, a polypropylene, a polyacetal, an acrylic resin, a polycarbonate (PC), a polyethylene terephthalate (PET), a polybutylene terephthalate (PBT), a polyether-ether ketone (PEEK), a polymethyl methacrylate (PMMA), and a silicone resin.

In a case where the thermally conductive member obtained by curing the thermally conductive silicone composition is used as a gap filler for battery units, a battery unit housing, which is a substrate to be bonded, may have an iron surface at least partially coated with a cationic electrodeposition coating on the substrate surface, and a heat sink may have an aluminum surface.

The thermally conductive silicone composition is injected and cured to fill a space between the aluminum surface and the iron surface coated by cationic electrodeposition coating therewith to provide a gap filler.

The electric apparatus and the electronic apparatus are not particularly limited, and examples thereof include a mobile phone, a smart phone, a tablet computer, a smart watch, a computer, a semiconductor package substrate, an electronic circuit substrate, an LED package substrate, a sensor substrate, an imaging device substrate, a liquid crystal substrate, and an organic EL substrate.

Method for producing thermally conductive silicone composition:

A first production method is a method for obtaining a cured product of a two-component thermally conductive silicone composition.

The first liquid contains the components (A), (B), (D), (E), and (F) described above.

The second liquid contains the components (B), (C), (D), and (F) described above. The second liquid may further contain the component (A).

The first liquid and/or the second liquid may further contain the above-mentioned component (G).

The first liquid and/or the second liquid may further contain the above-mentioned component (H).

In the first liquid production step, the components (A), (B), (D), and (E) are mixed, and the component (F) is then added to be mixed therewith.

### Component (A): Alkenyl Group-Containing Diorganopolysiloxane

Viscosity: 500 mPa·s or more and 7,000 mPa·s or less at 25° C.
Amount: 1.0 part by mass or more and 9.0 parts by mass or less relative to 100 parts by mass of the total amount of the first liquid

### Component (B): Organopolysiloxane

Viscosity: 10,000 mPa·s or more and 200,000 mPa·s or less at 25° C.
Amount: 0.05 parts by mass or more and 1.0 part by mass or less relative to 100 parts by mass of the total amount of the first liquid

### Component (D): Diorganopolysiloxane Having No Alkenyl Group

Viscosity: 500 mPa·s or less at 25° C.
Amount: 0.1 parts by mass or more and 9.0 parts by mass or less relative to 100 parts by mass of the total amount of the first liquid

### Component (E): Addition Reaction Catalyst

Amount: 0.01 parts by mass or more and 1.0 part by mass or less relative to 100 parts by mass of the total amount of the first liquid

### Component (F): Thermally Conductive Filler

Amount: 70.0 parts by mass or more and 95.0 parts by mass or less relative to 100 parts by mass of the total amount of the first liquid

In the first liquid production step, the components (A), (B), (D), (E), (G), and (H) may be mixed. The components (G) and (H) in this case are as follows:

### Component (G): Coupling Agent (SILANE 25013 VP Manufactured by Wacker Chemie AG)

Amount: 0.01 parts by mass or more and 2.0 parts by mass or less relative to 100 parts by mass of the total amount of the first liquid

### Component (H): Silanol Group-Containing Polydimethylsiloxane

Viscosity: 10 mPa·s or more and 1,000 mPa·s or less at 25° C.
Amount: 0.01 parts by mass or more and 2.0 parts by mass or less relative to 100 parts by mass of the total amount of the first liquid

In the second liquid production step, the components (A), (B), (C), and (D) are mixed, and the component (F) is then added to be mixed therewith.

### Component (A): Alkenyl Group-Containing Diorganopolysiloxane

Viscosity: 500 mPa·s or more and 7,000 mPa·s or less at 25° C.
Amount: 1.0 part by mass or more and 9.0 parts by mass or less relative to 100 parts by mass of the total amount of the second liquid

### Component (B): Organopolysiloxane

Viscosity: 10,000 mPa·s or more and 200,000 mPa·s or less at 25° C.
Amount: 0.05 parts by mass or more and 1.0 part by mass or less relative to 100 parts by mass of the total amount of the second liquid
   Component (C): Organopolysiloxane Having Two or More Hydrosilyl Groups within One Molecule
Viscosity: 10 mPa·s or more and 10,000 mPa·s or less at 25° C.
Amount: 0.01 parts by mass or more and 10.0 parts by mass or less relative to 100 parts by mass of the total amount of the second liquid

### Component (D): Diorganopolysiloxane Having No Alkenyl Group

Viscosity: 500 mPa·s or less at 25° C.
Amount: 0.1 parts by mass or more and 9.0 parts by mass or less relative to 100 parts by mass of the total amount of the second liquid

### Component (F): Thermally Conductive Filler

Amount: 70.0 parts by mass or more and 95.0 parts by mass or less relative to 100 parts by mass of the total amount of the second liquid

In the second liquid production step, the components (A), (B), (C), (D), (G), and (H) may be mixed. The components (G) and (H) in this case are as follows:

### Component (G): Coupling Agent

Amount: 0.01 parts by mass or more and 2.0 parts by mass or less relative to 100 parts by mass of the total amount of the second liquid

### Component (H): Silanol Group-Containing Polydimethylsiloxane

Viscosity: 10 mPa·s or more and 1,000 mPa·s or less at 25° C.
Amount: 0.01 parts by mass or more and 2.0 parts by mass or less relative to 100 parts by mass of the total amount of the second liquid

### Method for Producing Thermally Conductive Member:

A method for producing a thermally conductive member is a method including: placing the first liquid and the second liquid in a two-component internal mixing type dispenser; applying a predetermined pressure to each of the first liquid and the second liquid to mix the first liquid and the second liquid at a predetermined ratio; and discharging a predetermined amount of the mixed liquid toward a substrate.

Specifically, the production method includes:
a step of discharging the first liquid from a first liquid reservoir unit to a mixing unit;
a step of discharging the second liquid from a second liquid reservoir unit to the mixing unit;
a step of mixing the first liquid and the second liquid in the mixing unit to obtain a thermally conductive silicone composition (mixed liquid);
a step of applying the thermally conductive silicone composition to a substrate; and
a step of curing the thermally conductive silicone composition (mixed liquid), which has been applied to the substrate, to obtain a thermally conductive member.

Since the first liquid and the second liquid are used separately, there is no risk of caking until the liquids under the discharge pressure are discharged from the nozzle through the first liquid reservoir unit, the second liquid reservoir unit, and the mixing unit.

### EXAMPLE

The present invention will be specifically described on the basis of examples, but the present invention is not limited to the following examples. The blending ratio of each component of the examples is shown in Table 1, and evaluation results are shown in Table 3. The blending ratio of each component of the comparative example is shown in Table 2, and the evaluation results are shown in Table 4. The numerical values of the blending ratios shown in Table 1 and Table 2 are based on parts by mass. Note that the viscosity described herein refers to a value measured at 25° C. and at a shear rate of 10/s using a rotational viscometer (according to JIS K 7117-2).

The first liquid and the second liquid shown in Examples and Comparative Examples were prepared.

The first liquid and the second liquid were loaded into a dispenser (for example, a dispenser MPP-3 manufactured by Musashi Engineering Inc.) and discharged to a substrate. In the dispenser, the mixing ratio of the first liquid and the second liquid was set at a ratio of 1:1. The discharge pressure of the dispenser was set to 0.5 MPa.

Measurement method of mixing viscosity:

A viscosity of the mixed liquid discharged from the dispenser is measured by a rotational viscometer (according to JIS K7117-2) at 25° C. and at a shear rate of 10/s.

The viscosity is preferably 250 kPa or less.

Measurement method of thermal conductivity:

The mixed liquid discharged from the dispenser was press-molded into a columnar shape with a diameter of 30 mm and a height of 6 mm, and then was cured at 23° C. for 24 hours to produce a columnar cured product. The thermal conductivity of the cured product was measured by the hot disk method according to ISO 22007-2 using a measuring apparatus named TPS-500 manufactured by Kyoto Electronics Manufacturing Co., Ltd. A sensor was sandwiched between the two columnar cured products produced as above, and the thermal conductivity was measured by the measuring apparatus.

The thermal conductivity is preferably 2.0 W/m·K or higher.

Measurement method of hardness (ShoreOO):

The mixed liquid discharged from the dispenser was press-molded into a columnar shape with a diameter of 30 mm and a height of 6 mm, and then was cured at 23° C. for 24 hours to produce a columnar cured product. Hardness of the cured product was measured using a hardness meter ShoreOO manufactured by Teclock Co., Ltd., which is a machine that measures on the basis of a method according to JIS K 6253-3.

The ShoreOO is preferably between 30 and 80.

Caking measurement method:

Using a dispenser (MPP-3 manufactured by Musashi Engineering, Inc.), discharge of a material with a volume of 0.03 cc and a standby period of 0.20 seconds are repeated to discharge 1.0 kg of the material. The dispenser is then disassembled to examine occurrence of caking. The determination criteria, A, B, and C are as follows.
A: no aggregations are found,
B: aggregations of several millimeters in size are found, but there is no clogging in the flow path,
C: clogging occurs in the flow path.

Measurement method of initial discharge performance:

Using the dispenser (MPP-3 manufactured by Musashi Engineering, Inc.), a discharge pressure is set to 0.5 MPa, and discharging is performed for 10 seconds. The amount of discharged material is examined to calculate a discharged amount per unit time. The determination criteria, A, B, and C are as follows.
A: 0.2 cc/sec or more,
B: less than 0.2 cc/sec and 0.1 cc/sec or more,
C: less than 0.1 cc/sec

Measurement method of thread breakage properties:

Using the dispenser (MPP-3 manufactured by Musashi Engineering, Inc.) filled with the thermally conductive silicone composition, bead application is performed from a height of 2.5 mm above an aluminum plate to an area with a width of 10 mm and a length of 20 mm. Discharging is performed onto 5 locations with 10-mm intervals, and bead intervals at 4 locations are measured to calculate the average value. The closer the average value is to 10 mm, the better the thread breakage properties are, and the closer the average value is to 0 mm, the worse the thread breakage properties.

The evaluation results fall in the following three categories.
A (good): 6 mm or more
B (fair): 2 or more and less than 6 mm
C (poor): less than 2 mm

### First Liquid:

Based on the blending ratios in Table 1 and Table 2, the components (A), (B), (D), (E), (G), and (H) were each weighed and added together, and then kneaded for 30 minutes at room temperature using a planetary mixer. The component (F) was then added thereto and kneaded for 15 minutes at room temperature using the planetary mixer.

### Second Liquid:

Based on the blending ratios in Table 1 and Table 2, the components (A), (B), (C), (D), (G), and (H) were each weighed and added together, and then kneaded for 30 minutes at room temperature using a planetary mixer. The component (F) was then added thereto and kneaded for 15 minutes at room temperature using the planetary mixer.

TABLE 1

| | | Component/function | Conditions | 1 | 2 | 3 | 4 | 5 | 6 | 7 | 8 |
|---|---|---|---|---|---|---|---|---|---|---|---|
| First | A-1 | Base polymer | 25° C. 1000 mPa · s | 2.7% | 2.7% | | | 2.7% | 2.7% | 4.0% | 1.0% |
| Liquid | A-2 | | 25° C. 500 mPa · s | | | | 2.7% | | | | |
| | A-3 | | 25° C. 7,000 mPa · s | | | 2.7% | | | | | |
| | A-3 | | 25° C. 100 mPa · s | | | | | | | | |
| | B-1 | Separation-inhibition | 25° C. 100,000 mPa · s | 0.3% | 0.1% | 0.3% | 0.3% | | | 0.3% | 0.3% |
| | B-2 | polymer | 25° C. 200,000 mPa · s | | | | | 0.3% | | | |
| | B-3 | | 25° C. 1,000,000 mPa · s | | | | | | | | |
| | B-4 | | 25° C. 10,000 mPa · s | | | | | | 0.3% | | |
| | D-1 | Diorganopolysiloxane | 25° C. 50 mPa · s | 5.1% | 5.3% | 5.1% | 5.1% | 5.1% | 5.1% | 3.8% | 6.8% |
| | D-2 | without alkenyl group | 25° C. 500 mPa · s | | | | | | | | |
| | E | Addition reaction | Platinum catalyst | 0.2% | 0.2% | 0.2% | 0.2% | 0.2% | 0.2% | 0.2% | 0.2% |
| | | catalyst | | | | | | | | | |
| | G | Coupling agent | | 0.5% | 0.5% | 0.5% | 0.5% | 0.5% | 0.5% | 0.5% | 0.5% |
| | H | Silanol group- | 25° C. 50 mPa · s | 0.3% | 0.3% | 0.3% | 0.3% | 0.3% | 0.3% | 0.3% | 0.3% |
| | | containing | | | | | | | | | |
| | | polydimethylsiloxane | | | | | | | | | |
| | F-1 | Filler | Amorphous zinc oxide, | 6.0% | 6.0% | 6.0% | 6.0% | 6.0% | 6.0% | 6.0% | 6.0% |
| | | | amorphous form with average | | | | | | | | |
| | | | particle size of 0.6 μm | | | | | | | | |
| | F-2 | | Amorphous aluminum oxide, | 30.0% | 30.0% | 30.0% | 30.0% | 30.0% | 30.0% | 30.0% | 30.0% |
| | | | amorphous form with average | | | | | | | | |
| | | | particle size of 4 μm | | | | | | | | |
| | F-3 | | Spherical aluminum oxide, | 55.0% | 55.0% | 55.0% | 55.0% | 55.0% | 55.0% | 55.0% | 55.0% |
| | | | spherical form with average | | | | | | | | |
| | | | particle size of 50 μm | | | | | | | | |
| | | | Total | 100.0% | 100.0% | 100.0% | 100.0% | 100.0% | 100.0% | 100.0% | 100.0% |
| Second | A-1 | Base polymer | 25° C. 1,000 mPa · s | 2.5% | 2.5% | | | 2.5% | 2.5% | 4.0% | 1.0% |
| Liquid | A-2 | | 25° C. 500 mPa · s | | | | 2.5% | | | | |
| | A-3 | | 25° C. 7,000 mPa · s | | | 2.5% | | | | | |
| | A-3 | | 25° C. 100 mPa · s | | | | | | | | |
| | B-1 | Separation-inhibition | 25° C. 100,000 mPa · s | 0.3% | 0.1% | 0.3% | 0.3% | | | 0.3% | 0.3% |
| | B-2 | polymer | 25° C. 200,000 mPa · s | | | | | 0.3% | | | |
| | B-3 | | 25° C. 1,000,000 mPa · s | | | | | | | | |
| | B-4 | | 25° C. 10,000 mPa · s | | | | | | 0.3% | | |
| | C | Cross-linking agent | Side chain SiH | 0.4% | 0.4% | 0.4% | 0.4% | 0.4% | 0.4% | 0.4% | 0.4% |
| | D-1 | Diorganopolysiloxane | 25° C. 50 mPa · s | 5.0% | 5.3% | 5.0% | 5.0% | 5.0% | 5.0% | 3.6% | 6.6% |
| | D-2 | without alkenyl group | 25° C. 500 mPa · s | | | | | | | | |
| | G | Coupling agent | | 0.5% | 0.5% | 0.5% | 0.5% | 0.5% | 0.5% | 0.5% | 0.5% |
| | H | Silanol group- | 25° C. 50 mPa · s | 0.3% | 0.3% | 0.3% | 0.3% | 0.3% | 0.3% | 0.3% | 0.3% |
| | | containing | | | | | | | | | |
| | | polydimethylsiloxane | | | | | | | | | |
| | F-1 | Filler | Amorphous zinc oxide, | 6.0% | 6.0% | 6.0% | 6.0% | 6.0% | 6.0% | 6.0% | 6.0% |
| | | | amorphous form with average | | | | | | | | |
| | | | particle size of 0.6 μm | | | | | | | | |
| | F-2 | | Amorphous aluminum oxide, | 30.0% | 30.0% | 30.0% | 30.0% | 30.0% | 30.0% | 30.0% | 30.0% |
| | | | amorphous form with average | | | | | | | | |
| | | | particle size of 4 μm | | | | | | | | |
| | F-3 | | Spherical aluminum oxide, | 55.0% | 55.0% | 55.0% | 55.0% | 55.0% | 55.0% | 55.0% | 55.0% |
| | | | spherical form with average | | | | | | | | |
| | | | particle size of 50 μm | | | | | | | | |
| | | | Total | 100.0% | 100.0% | 100.0% | 100.0% | 100.0% | 100.0% | 100.0% | 100.0% |

| | | Component/function | Conditions | 9 | 10 | 11 | 12 | 13 | 14 | 15 |
|---|---|---|---|---|---|---|---|---|---|---|
| First | A-1 | Base polymer | 25° C. 1000 mPa · s | 2.7% | 2.7% | 2.7% | 9.0% | | 2.7% | 2.7% |
| Liquid | A-2 | | 25° C. 500 mPa · s | | | | | 5.5% | | |
| | A-3 | | 25° C. 7,000 mPa · s | | | | | | | |
| | A-3 | | 25° C. 100 mPa · s | | | | | | | |
| | B-1 | Separation-inhibition | 25° C. 100,000 mPa · s | 1.0% | 0.05% | 0.3% | 0.3% | 0.3% | 0.3% | 0.3% |
| | B-2 | polymer | 25° C. 200,000 mPa · s | | | | | | | |
| | B-3 | | 25° C. 1,000,000 mPa · s | | | | | | | |
| | B-4 | | 25° C. 10,000 mPa · s | | | | | | | |
| | D-1 | Diorganopolysiloxane | 25° C. 50 mPa · s | 4.4% | 5.3% | | 4.8% | 2.3% | 5.3% | 5.6% |
| | D-2 | without alkenyl group | 25° C. 500 mPa · s | | | 5.1% | | | | |
| | E | Addition reaction | Platinum catalyst | 0.2% | 0.2% | 0.2% | 0.2% | 0.2% | 0.2% | 0.2% |
| | | catalyst | | | | | | | | |
| | G | Coupling agent | | 0.5% | 0.5% | 0.5% | 0.5% | 0.5% | 0.5% | |
| | H | Silanol group- | 25° C. 50 mPa · s | 0.3% | 0.3% | 0.3% | 0.3% | 0.3% | | 0.3% |
| | | containing | | | | | | | | |
| | | polydimethylsiloxane | | | | | | | | |
| | F-1 | Filler | Amorphous zinc oxide, | 6.0% | 6.0% | 6.0% | 5.0% | 6.0% | 6.0% | 6.0% |
| | | | amorphous form with average | | | | | | | |
| | | | particle size of 0.6 μm | | | | | | | |
| | F-2 | | Amorphous aluminum oxide, | 30.0% | 30.0% | 30.0% | 27.0% | 30.0% | 30.0% | 30.0% |
| | | | amorphous form with average | | | | | | | |
| | | | particle size of 4 μm | | | | | | | |
| | F-3 | | Spherical aluminum oxide, | 55.0% | 55.0% | 55.0% | 53.0% | 55.0% | 55.0% | 55.0% |
| | | | spherical form with average | | | | | | | |
| | | | particle size of 50 μm | | | | | | | |
| | | | Total | 100.0% | 100.0% | 100.0% | 100.0% | 100.0% | 100.0% | 100.0% |
| Second | A-1 | Base polymer | 25° C. 1,000 mPa · s | 2.5% | 2.5% | 2.5% | 9.0% | | 2.7% | 2.7% |
| Liquid | A-2 | | 25° C. 500 mPa · s | | | | | | | |
| | A-3 | | 25° C. 7,000 mPa · s | | | | | | | |
| | A-3 | | 25° C. 100 mPa · s | | | | | | | |
| | B-1 | Separation-inhibition | 25° C. 100,000 mPa · s | 1.0% | 0.05% | 0.3% | 0.3% | | 0.3% | 0.3% |
| | B-2 | polymer | 25° C. 200,000 mPa · s | | | | | 0.3% | | |
| | B-3 | | 25° C. 1,000,000 mPa · s | | | | | | | |
| | B-4 | | 25° C. 10,000 mPa · s | | | | | | | |
| | C | Cross-linking agent | Side chain SiH | 0.4% | 0.4% | 0.4% | 0.2% | 0.4% | 0.4% | 0.4% |
| | D-1 | Diorganopolysiloxane | 25° C. 50 mPa · s | 4.4% | 5.3% | | 4.8% | | 4.8% | 5.3% |
| | D-2 | without alkenyl group | 25° C. 500 mPa · s | | | 5.0% | | 7.5% | | |
| | G | Coupling agent | | 0.5% | 0.5% | 0.5% | 0.5% | 0.5% | 0.5% | |
| | H | Silanol group- | 25° C. 50 mPa · s | 0.3% | 0.3% | 0.3% | 0.3% | 0.3% | 0.3% | 0.3% |
| | | containing | | | | | | | | |
| | | polydimethylsiloxane | | | | | | | | |
| | F-1 | Filler | Amorphous zinc oxide, | 6.0% | 6.0% | 6.0% | 5.0% | 6.0% | 6.0% | 6.0% |
| | | | amorphous form with average | | | | | | | |
| | | | particle size of 0.6 μm | | | | | | | |
| | F-2 | | Amorphous aluminum oxide, | 30.0% | 30.0% | 30.0% | 27.0% | 30.0% | 30.0% | 30.0% |
| | | | amorphous form with average | | | | | | | |
| | | | particle size of 4 μm | | | | | | | |
| | F-3 | | Spherical aluminum oxide, | 55.0% | 55.0% | 55.0% | 53.0% | 55.0% | 55.0% | 55.0% |
| | | | spherical form with average | | | | | | | |
| | | | particle size of 50 μm | | | | | | | |
| | | | Total | 100.0% | 100.0% | 100.0% | 100.0% | 100.0% | 100.0% | 100.0% |

TABLE 2

| | | Component/function | Conditions | 1 | 2 | 3 |
|---|---|---|---|---|---|---|
| First | A-1 | Base polymer | 25° C. 1,000 mPa · s | | 2.7% | |
| Liquid | A-2 | | 25° C. 500 mPa · s | | | |
| | A-3 | | 25° C. 7,000 mPa · s | | | |
| | A-3 | | 25° C.: 100 mPa · s | 2.7% | | 11.3% |
| | B-1 | Separation-inhibition | 25° C. 100,000 mPa · s | 0.3% | | 1.3% |
| | B-2 | polymer | 25° C. 200,000 mPa · s | | | |
| | B-3 | | 25° C. 1,000,000 mPa · s | | 0.3% | |
| | B-4 | | 25° C. 10,000 mPa · s | | | |
| | D-1 | Diorganopolysiloxane | 25° C. 50 mPa · s | 5.1% | 5.1% | 21.7% |
| | D-2 | without alkenyl group | 25° C. 500 mPa · s | | | |
| | E | Addition reaction catalyst | Platinum catalyst | 0.2% | 0.2% | 0.6% |
| | G | Coupling agent | | 0.5% | 0.5% | 2.1% |
| | H | Silanol group-containing | 25° C. 50 mPa · s | 0.3% | 0.3% | 1.0% |
| | | polydimethylsiloxane | | | | |
| | F-1 | Filler | Amorphous zinc oxide, amorphous form | 6.0% | 6.0% | 4.0% |
| | | | with average particle size of 0.6 μm | | | |
| | F-2 | | Amorphous aluminum oxide, amorphous | 30.0% | 30.0% | 20.0% |
| | | | form with average particle size of 4 μm | | | |
| | F-3 | | Spherical aluminum oxide, spherical | 55.0% | 55.0% | 38.0% |
| | | | form with average particle size of 50 μm | | | |
| | | | Total | 100.0% | 100.0% | 100.0% |
| Second | A-1 | Base polymer | 25° C. 1,000 mPa · s | | 2.7% | 11.2% |
| Liquid | A-2 | | 25° C. 500 mPa · s | | | |
| | A-3 | | 25° C. 7,000 mPa · s | | | |
| | A-3 | | 25° C. 100 mPa · s | 2.7% | | |
| | B-1 | Separation-inhibition | 25° C.: 100,000 mPa · s | 0.3% | | 1.2% |
| | B-2 | polymer | 25° C. 200,000 mPa · s | | | |
| | B-3 | | 25° C. 1,000,000 mPa · s | | 0.3% | |
| | B-4 | | 25° C.: 10,000 mPa · s | | | |
| | C | Cross-linking agent | Side chain SiH | 0.4% | 0.4% | 1.5% |
| | D-1 | Diorganopolysiloxane | 25° C. 50 mPa · s | 4.8% | 4.8% | 21.0% |
| | D-2 | without alkenyl group | 25° C. 500 mPa · s | | | |
| | G | Coupling agent | | 0.5% | 0.5% | 2.1% |
| | H | Silanol group-containing | 25° C. 50 mPa · s | 0.3% | 0.3% | 1.0% |
| | | polydimethylsiloxane | | | | |
| | F-1 | Filler | Amorphous zinc oxide, amorphous form | 6.0% | 6.0% | 4.0% |
| | | | with average particle size of 0.6 μm | | | |
| | F-2 | | Amorphous aluminum oxide, amorphous | 30.0% | 30.0% | 20.0% |
| | | | form with average particle size of 4 μm | | | |
| | F-3 | | Spherical aluminum oxide, spherical | 55.0% | 55.0% | 38.0% |
| | | | form with average particle size of 50 μm | | | |
| | | | Total | 100.0% | 100.0% | 100.0% |

### Components

(A-1): A linear dimethylpolysiloxane having one alkenyl group at each terminal and a viscosity of 1,000 mPa·s
(A-2): A linear dimethylpolysiloxane having one alkenyl group at each terminal and a viscosity of 500 mPa·s
(A-3): A linear dimethylpolysiloxane having one alkenyl group at each terminal and a viscosity of 7,000 mPa·s
(A-4): A linear dimethylpolysiloxane having one alkenyl group at each terminal and a viscosity of 100 mPa·s
(B-1): A linear organopolysiloxane having a viscosity of 100,000 mPa·s
(B-2): A linear organopolysiloxane having a viscosity of 200,000 mPa·s
(B-3): A linear organopolysiloxane having a viscosity of 1,000,000 mPa·s
(B-4): A linear organopolysiloxane having a viscosity of 10,000 mPa·s
(C): A dimethylpolysiloxane having 12 to 18 hydrogen atoms bonded to silicon atoms in the side chains and a viscosity of 200 mPa·s
(D-1): A linear dimethylpolysiloxane having no alkenyl groups and having a viscosity of 50 mPa·s
(D-2): A linear dimethylpolysiloxane having no alkenyl groups and having a viscosity of 500 mPa·s
(E): A platinum-divinyltetramethyldisiloxane complex
(F-1): Amorphous zinc oxide (average particle diameter (D50): 0.6 μm, BET specific surface area: 4.1 m²/g)
(F-2) Amorphous aluminum oxide (average particle diameter (D50): 3.9 μm, BET specific surface area: 0.9 m²/g)
(F-3) Spherical aluminum oxide (average particle diameter (D50): 40 μm, BET specific surface area: 0.12 m²/g).
(G): SILANE 25013 VP manufactured by Wacker Chemie AG
(H): A linear diorganopolysiloxane having one silanol group at each terminal and a viscosity of 50 mPa·s

### Evaluation:

Table 3 shows the evaluation results of Examples 1 to 15.

In Example 1, a polymer with an appropriate viscosity was used as a base polymer, and a separation-inhibition polymer with an appropriate viscosity was introduced. This formulation prevented caking, and achieved good discharge performance, thread breakage properties, and a high thermal conductivity.

In Example 2, less separation-inhibition polymer was included, relative to that of Example 1. As a result, caking was reduced to some degree (to the extent of not causing any problem in practical use), and performance indicators were favorable.

In Example 3, a polymer with a slightly high viscosity was used as the base polymer, and the separation-inhibition polymer with an appropriate viscosity was introduced. This formulation prevented caking, and achieved relatively good discharge performance, good thread breakage properties, and a high thermal conductivity.

In Example 4, a polymer with a slightly low viscosity was used as the base polymer, and the separation-inhibition polymer with an appropriate viscosity was introduced. This formulation prevented caking to some degree, and achieved good discharge performance, good thread breakage properties, and a high thermal conductivity.

In Example 5, a polymer with an appropriate viscosity was used as the base polymer, and the separation-inhibition polymer with a slightly high viscosity was introduced. This formulation prevented caking, and achieved relatively good discharge performance, good thread breakage properties, and a high thermal conductivity.

In Example 6, a polymer with an appropriate viscosity was used as the base polymer, and the separation-inhibition polymer with a slightly low viscosity was introduced. This formulation reduced caking to some degree, and achieved good discharge performance, good thread breakage properties, and a high thermal conductivity.

In Example 7, a polymer with an appropriate viscosity was used as the base polymer, the separation-inhibition polymer with an appropriate viscosity was introduced, and the amount of the base polymer was increased. This formulation prevented caking, and achieved relatively good discharge performance, good thread breakage properties, and a high thermal conductivity.

In Example 8, a polymer with an appropriate viscosity was used as the base polymer, the separation-inhibition polymer with an appropriate viscosity was introduced, and the amount of the base polymer was decreased. This formulation reduced caking to some degree, and achieved good discharge performance, good thread breakage properties, and a high thermal conductivity.

In Example 9, a polymer with an appropriate viscosity was used as the base polymer, the separation-inhibition polymer with an appropriate viscosity was introduced, and the amount of the separation-inhibition polymer was increased. This formulation prevented caking, and achieved relatively good discharge performance, good thread breakage properties, and a high thermal conductivity.

In Example 10, a polymer with an appropriate viscosity was used as the base polymer, the separation-inhibition polymer with an appropriate viscosity was introduced, and the amount of the separation-inhibition polymer was decreased. This formulation prevented caking, and achieved relatively good discharge performance, good thread breakage properties, and a high thermal conductivity.

In Example 11, a polymer with an appropriate viscosity was used as the base polymer, the separation-inhibition polymer with an appropriate viscosity was introduced, and dimethyl oil with a slightly high viscosity (500 mPa·s) was used for adjusting the viscosity. This formulation prevented caking, and achieved relatively good discharge performance, good thread breakage properties, and a high thermal conductivity.

In Example 12, a polymer with an appropriate viscosity was used as the base polymer, the separation-inhibition polymer with an appropriate viscosity was introduced, and the thermal conductive filler was adjusted to be in an amount of 85%. This formulation prevented caking, and achieved good discharge performance, good thread breakage properties, and a high thermal conductivity.

In Example 13, no base polymer was used in the second liquid, the amount of the base polymer introduced into the first liquid was increased, a polymer with an appropriate viscosity was used as the base polymer, and the separation-inhibition polymer with an appropriate viscosity was introduced. This formulation prevented caking, and achieved relatively good discharge performance, good thread breakage properties, and a high thermal conductivity.

In Example 14, a polymer with an appropriate viscosity was used as the base polymer, the separation-inhibition polymer with an appropriate viscosity was introduced, and the use of the component (H) was omitted. This formulation prevented caking and achieved good discharge performance and a high thermal conductivity. However, not using the component (H) caused poor thread breakage properties.

In Example 15, a polymer with an appropriate viscosity was used as the base polymer, the separation-inhibition polymer with an appropriate viscosity was introduced, and the use of the component (G) was omitted. This formulation prevented caking and achieved good thread breakage properties and a high thermal conductivity. However, not using the component (G) resulted in a less preferable discharge performance.

Table 4 shows the evaluation results of Comparative examples 1 to 3.

In Comparative example 1, a polymer with a low viscosity was used as the base polymer, and the separation-inhibition polymer with an appropriate viscosity was introduced, resulting in the occurrence of caking. Nevertheless, the discharge performance was good, and the thermal conductivity was high.

In Comparative example 2, a polymer with an appropriate viscosity was used as the base polymer, and the separation-inhibition polymer with a high viscosity was introduced. Although this formulation prevented caking, the discharge performance and thread breakage properties were poor. Nevertheless, the thermal conductivity was high.

In Comparative example 3, a polymer with a low viscosity was used as the base polymer, the filler amount was decreased, and the separation-inhibition polymer with an appropriate viscosity was introduced. This formulation prevented caking and achieved good discharge performance and thread breakage properties. However, the thermal conductivity was low.

TABLE 3

| | Good product | | | | | | | | | | | | | | | |
|---|---|---|---|---|---|---|---|---|---|---|---|---|---|---|---|---|
| | determination | | | | | | | | | | | | | | | |
| Test items | criteria | 1 | 2 | 3 | 4 | 5 | 6 | 7 | 8 | 9 | 10 | 11 | 12 | 13 | 14 | 15 |
| First liquid viscosity | ≤250 kPa | 140 | 140 | 250 | 120 | 190 | 140 | 220 | 80 | 250 | 140 | 240 | 220 | 100 | 140 | 220 |
| Second liquid viscosity | ≤250 kPa | 140 | 140 | 250 | 120 | 190 | 140 | 220 | 80 | 250 | 140 | 240 | 220 | 230 | 140 | 220 |
| Mixing viscosity | ≤250 kPa | 140 | 140 | 250 | 120 | 190 | 140 | 220 | 80 | 250 | 140 | 240 | 220 | 140 | 140 | 220 |
| Thermal conductivity | ≥2.0 | 3.0 | 3.0 | 3.0 | 3.0 | 3.0 | 3.0 | 3.0 | 3.0 | 3.0 | 3.0 | 3.0 | 2.0 | 3.0 | 3.0 | 3.0 |
| Hardness (Shore00) | 30-80 | 50.0 | 50.0 | 70.0 | 35.0 | 55.0 | 45.0 | 60.0 | 40.0 | 55.0 | 48.0 | 58.0 | 45.0 | 45.0 | 48.0 | 50.0 |
| Caking | ≥B | A | B | A | B | A | B | A | B | A | B | A | A | A | A | A |
| Initial discharge | ≥B | A | A | B | A | B | A | B | A | B | A | B | A | A | A | B |
| performance | | | | | | | | | | | | | | | | |
| Thread breakage | No thread | A | A | A | A | A | A | A | A | A | A | A | A | A | C | A |
| properties | breakage by | | | | | | | | | | | | | | | |
| | visual | | | | | | | | | | | | | | | |
| | inspection | | | | | | | | | | | | | | | |

TABLE 4

| | Good product | | | |
|---|---|---|---|---|
| Test items | determination criteria | 1 | 2 | 3 |
| First liquid viscosity | ≤250 kPa | 100 | 250 | 50 |
| Second liquid viscosity | ≤250 kPa | 100 | 250 | 50 |
| Mixing viscosity | ≤250 kPa | 100 | 270 | 20 |
| Thermal conductivity | ≥2.0 | 3.0 | 3.0 | 1.0 |
| Hardness (Shore00) | 30-80 | 40.0 | 53.0 | 40.0 |
| Caking | ≥B | C | A | B |
| Initial discharge | ≥B | A | C | A |
| performance | | | | |
| Thread breakage | No thread breakage | A | C | A |
| properties | by visual inspection | | | |

1-11. (canceled)

12. A thermally conductive silicone composition, comprising:
a component (A), wherein the component (A) is an alkenyl group-containing diorganopolysiloxane, having a viscosity of 500 mPa·s or more and 7,000 mPa·s or less at 25° C., in an amount of 1.0 part by mass or more and 9.0 parts by mass or less;
a component (B), wherein the component (B) is an organopolysiloxane, having a viscosity of 10,000 mPa·s or more and 200,000 mPa·s or less at 25° C., in an amount of 0.05 parts by mass or more and 1.0 part by mass or less;
a component (C), wherein the component (C) is an organopolysiloxane having two or more hydrosilyl groups within one molecule;
a component (D), wherein the component (D) is a diorganopolysiloxane having no alkenyl group, having a viscosity of 500 mPa·s or less at 25° C.;
a component (E), wherein the component (E) is an addition reaction catalyst;
a component (F), wherein the component (F) is at least one or two or more thermally conductive fillers selected from the group consisting of a metal, a metal oxide, a metal hydroxide, a metal nitride, and a metal carbide, wherein the component (F) is present in an amount of 85 parts by mass or more relative to 100 parts by mass of the entire thermally conductive silicone composition;
wherein the thermally conductive silicone composition has a mixing viscosity of 250 Pa·s or less at 25° C.; and
wherein the organopolysiloxane of the component (C) is different from the components (A), (B), and (D).

13. The thermally conductive silicone composition of claim 12, further comprising a component (H) that is a silanol group-containing polydimethylsiloxane.

14. The thermally conductive silicone composition of claim 12, wherein the thermally conductive silicone composition is a two-component thermally conductive silicone composition including a first liquid and a second liquid separated from each other, the first liquid and the second liquid being mixed when used;
wherein the first liquid contains the components (A), (B), (D), (E) and (F); and
wherein the second liquid contains the components (B), (C), (D), and (F), but not the component (E).

15. The thermally conductive silicone composition of claim 14, wherein the first liquid and/or the second liquid further comprises a component (H) that is a silanol group-containing polydimethylsiloxane.

16. The thermally conductive silicone composition of claim 14, wherein in the thermally conductive silicone composition, no aggregation is observed in any of the first liquid, the second liquid, and the thermally conductive silicone composition in a caking evaluation; and
wherein the caking evaluation uses a dispenser, discharging a material with a volume of 0.03 cc and a standby period of 0.20 seconds are repeated to discharge 1.0 kg of the material, and the dispenser is then disassembled to visually check for aggregation.

17. A method for producing a thermally conductive silicone composition, comprising:
providing a first liquid production step of mixing a component (A) that is an alkenyl group-containing diorganopolysiloxane, having a viscosity of 500 mPa·s or more and 7,000 mPa·s or less at 25° C., in an amount of 1.0 part by mass or more and 9.0 parts by mass or less, a component (B) that is an organopolysiloxane, having a viscosity of 10,000 mPa·s or more and 200,000 mPa·s or less at 25° C., in an amount of 0.05 parts by mass or more and 1.0 part by mass or less, a component (D) that is a non-functional diorganopolysiloxane having no alkenyl group, having a viscosity of 500 mPa·s or less at 25° C., and a component (E) that is an addition reaction catalyst, and then mixing a component (F) that is at least one or two or more thermally conductive fillers selected from the group consisting of a metal, a metal oxide, a metal hydroxide, a metal nitride, and a metal carbide, to obtain a first liquid;
providing a second liquid production step of mixing the component (B) that is an organopolysiloxane, having a viscosity of 10,000 mPa·s or more and 200,000 mPa·s or less at 25° C., in an amount of 0.05 parts by mass or more and 1.0 part by mass or less, a component (C) that is an organopolysiloxane having two or more hydrosilyl groups within one molecule, the component (D) that is a non-functional diorganopolysiloxane having no alkenyl group, having a viscosity of 500 mPa·s or less at 25° C., and the component (F) that is at least one or two or more thermally conductive fillers selected from the group consisting of a metal, a metal oxide, a metal hydroxide, a metal nitride, and a metal carbide, to obtain a second liquid; and
wherein the organopolysiloxane of the component (C) is different from the components (A), (B), and (D).

18. The method of claim 17, wherein before the component (F) is added in the second liquid production step, the component (A) that is an alkenyl group-containing diorganopolysiloxane, having a viscosity of 500 mPa·s or more and 7,000 mPa·s or less at 25° C., in an amount of 1.0 part by mass or more and 9.0 parts by mass or less is mixed with the other components.

19. The method of claim 17, wherein, before the component (F) is added in the first liquid production step and/or the second liquid production step, a component (H) that is a silanol group-containing polydimethylsiloxane is mixed with the other components.

20. A method for producing a thermally conductive member, comprising:
providing a thermally conductive silicone composition comprising a component (A), a component (B), a component (C), a component (D), a component (E) and a component (F),
wherein the component (A) is an alkenyl group-containing diorganopolysiloxane, having a viscosity of 500 mPa·s or more and 7,000 mPa·s or less at 25° C., in an amount of 1.0 part by mass or more and 9.0 parts by mass or less,
wherein the component (B) is an organopolysiloxane, having a viscosity of 10,000 mPa·s or more and 200,000 mPa·s or less at 25° C., in an amount of 0.05 parts by mass or more and 1.0 part by mass or less,
wherein the component (C) is an organopolysiloxane having two or more hydrosilyl groups within one molecule,
wherein the component (D) is a diorganopolysiloxane having no alkenyl group, having a viscosity of 500 mPa·s or less at 25° C.,
wherein the component (E) is an addition reaction catalyst,
wherein the component (F) is at least one or two or more thermally conductive fillers selected from the group consisting of a metal, a metal oxide, a metal hydroxide, a metal nitride, and a metal carbide, wherein the component (F) is present in an amount of 85 parts by mass or more relative to 100 parts by mass of the entire thermally conductive silicone composition,
wherein the thermally conductive silicone composition has a mixing viscosity of 250 Pa·s or less at 25° C.,
wherein the organopolysiloxane of the component (C) is different from the components (A), (B), and (D),
wherein the thermally conductive silicone composition is a two-component thermally conductive silicone composition including a first liquid and a second liquid separated from each other, the first liquid and the second liquid being mixed when used,
wherein the first liquid contains the components (A), (B), (D), (E) and (F), and
wherein the second liquid contains the components (B), (C), (D), and (F), but not the component (E);
discharging the first liquid from a first liquid storage unit to a mixing unit;
discharging the second liquid from a second liquid storage unit to the mixing unit;
mixing the first liquid and the second liquid in the mixing unit to obtain a thermally conductive silicone composition;
discharging and applying the thermally conductive silicone composition onto a substrate; and
curing the thermally conductive silicone composition applied onto the substrate to obtain a thermally conductive member.

21. A method for producing a heat-dissipating member, comprising:
providing a thermally conductive silicone composition comprising a component (A), a component (B), a component (C), a component (D), a component (E) and a component (F),
wherein the component (A) is an alkenyl group-containing diorganopolysiloxane, having a viscosity of 500 mPa·s or more and 7,000 mPa·s or less at 25° C., in an amount of 1.0 part by mass or more and 9.0 parts by mass or less,
wherein the component (B) is an organopolysiloxane, having a viscosity of 10,000 mPa·s or more and 200,000 mPa·s or less at 25° C., in an amount of 0.05 parts by mass or more and 1.0 part by mass or less,
wherein the component (C) is an organopolysiloxane having two or more hydrosilyl groups within one molecule,
wherein the component (D) is a diorganopolysiloxane having no alkenyl group, having a viscosity of 500 mPa·s or less at 25° C.,
wherein the component (E) is an addition reaction catalyst,
wherein the component (F) is at least one or two or more thermally conductive fillers selected from the group consisting of a metal, a metal oxide, a metal hydroxide, a metal nitride, and a metal carbide, wherein the component (F) is present in an amount of 85 parts by mass or more relative to 100 parts by mass of the entire thermally conductive silicone composition,
wherein the thermally conductive silicone composition has a mixing viscosity of 250 Pa·s or less at 25° C.,
wherein the organopolysiloxane of the component (C) is different from the components (A), (B), and (D);
providing a substrate and a thermally conductive member disposed on a surface of the substrate, the thermally conductive member being any of thermally conductive members including a thermally conductive member obtained by curing the thermally conductive silicone composition;
obtaining a thermally conductive member by curing the thermally conductive silicone composition, wherein the thermally conductive silicone composition is obtained by providing a first liquid production step of mixing a component (A) that is an alkenyl group-containing diorganopolysiloxane, having a viscosity of 500 mPa·s or more and 7,000 mPa·s or less at 25° C., in an amount of 1.0 part by mass or more and 9.0 parts by mass or less, a component (B) that is an organopolysiloxane, having a viscosity of 10,000 mPa·s or more and 200,000 mPa·s or less at 25° C., in an amount of 0.05 parts by mass or more and 1.0 part by mass or less, a component (D) that is a non-functional diorganopolysiloxane having no alkenyl group, having a viscosity of 500 mPa·s or less at 25° C., and a component (E) that is an addition reaction catalyst, and then mixing a component (F) that is at least one or two or more thermally conductive fillers selected from the group consisting of a metal, a metal oxide, a metal hydroxide, a metal nitride, and a metal carbide, to obtain a first liquid,
providing a second liquid production step of mixing the component (B) that is an organopolysiloxane, having a viscosity of 10,000 mPa·s or more and 200,000 mPa·s or less at 25° C., in an amount of 0.05 parts by mass or more and 1.0 part by mass or less, a component (C) that is an organopolysiloxane having two or more hydrosilyl groups within one molecule, the component (D) that is a non-functional diorganopolysiloxane having no alkenyl group, having a viscosity of 500 mPa·s or less at 25° C., and the component (F) that is at least one or two or more thermally conductive fillers selected from the group consisting of a metal, a metal oxide, a metal hydroxide, a metal nitride, and a metal carbide, to obtain a second liquid, and
wherein the organopolysiloxane of the component (C) is different from the components (A), (B), and (D); and
obtaining a thermally conductive member, wherein the thermally conductive member is obtained by obtaining thermally conductive silicone composition, wherein the thermally conductive silicone composition is a two-component thermally conductive silicone composition including a first liquid and a second liquid separated from each other, the first liquid and the second liquid being mixed when used, wherein the first liquid contains the components (A), (B), (D), (E) and (F), and wherein the second liquid contains the components (B), (C), (D), and (F), but not the component (E), wherein the first liquid is discharged from a first liquid storage unit to a mixing unit, herein the second liquid is discharged from a second liquid storage unit to the mixing unit, wherein the first liquid and the second liquid are mixed together in the mixing unit to obtain a thermally conductive silicone composition, wherein the thermally conductive silicone composition is discharged and applied onto a substrate, and wherein the thermally conductive silicone composition is cured and applied onto the substrate to obtain a thermally conductive member.

22. The method of claim 21, wherein the heat-dissipating member is integrated within an electrical device.
